(19) United States
(12) Patent Application Publication
(10) Pub. No.: US 2026/0121428 A1
(43) Pub. Date: Apr. 30, 2026

(54) SYSTEMS AND METHODS FOR APPLICATION SPECIFIC BATTERY CONTAINER CONFIGURATIONS

(71) Applicant: Caterpillar Inc., Peoria, IL (US)

(72) Inventors: Chethan Ramakrishnaiah, Bengaluru (IN); Manoj Kumar Bantupalli, Bangalore (IN); Ranjay Singh, Bangalore (IN); Gregory Scott Hasler, Pekin, IL (US)

(73) Assignee: Caterpillar Inc., Peoria, IL (US)

(21) Appl. No.: 18/929,068

(22) Filed: Oct. 28, 2024

(51) Int. Cl. H02J 7/00; H02J 1/10; H02J 7/34

(52) U.S. Cl. CPC H02J 7/575; H02J 1/106; H02J 7/34; H02J 7/44

(57) ABSTRACT

At least one aspect of the present disclosure is directed to systems and methods for application specific battery container configurations. A controller can receive, from the microgrid, an indication of demand for power to complete operations within a worksite. The microgrid supplied with power from one or more of a plurality of energy containers in a first configuration. The controller can determine to identify a second configuration for the plurality of energy containers, based on the first configuration as compared to a one or more criteria. The controller can identify the second configuration of the plurality of energy containers, which satisfies the one or more criteria. The controller can modify a configuration of the plurality of energy containers to complete the operations within the worksite, from the first configuration to the second configuration.

### TECHNICAL FIELD

The present implementations relate generally to the field of battery container configurations, and more particularly systems and methods for application specific battery container configurations.

### BACKGROUND

Battery container configurations may be used in power transmission to provide energy to a microgrid according to the demands, loads, and needs of the microgrid. In some implementations, a battery container configuration may be efficient for a specific need of the microgrid. Battery container configurations allows for the integration of various energy sources, such as renewable energy plants, to facilitate the transfer of large amounts of electricity.

For example, U.S. patent application Ser. No. 11/529,884 describes a vehicle-based microgrid that includes a controller, a vehicle having a power source and a network. The controller is operable to operate the power source to supply power to the network for consumption by loads on the network, and to adjust operation of the power source in supplying power to the network upon a battery source being added to the network. The power source may be (i) a traction battery, (ii) an electrical generator, or (iii) a non-traction battery. The battery source may be (i) a battery that is on-board the vehicle and that is not the power source or (ii) a battery that is off board the vehicle.

### SUMMARY

A first aspect provided herein relate to a method for application specific battery container configurations. The method can include receiving, by a controller from the microgrid, an indication of demand for power to complete operations within a worksite. The microgrid supplied with power from one or more of a plurality of energy containers in a first configuration. The method can include determining, by the controller, to identify a second configuration for the plurality of energy containers, based on one or more metrics of the first configuration as compared to a one or more criteria. The method can include identifying, by the controller, the second configuration of the plurality of energy containers, having one or more metrics which satisfy the one or more criteria. The method can include modifying, by the controller, a configuration of the plurality of energy containers to complete the operations within the worksite, from the first configuration to the second configuration.

A second aspect provided herein relate to a controller. The controller can include one or more processors coupled with memory storing instructions that, when executed by the one or more processors, cause the one or more processors to receive from a microgrid, an indication of demand for power to complete operations within a worksite. The microgrid supplied with power from one or more of a plurality of energy containers in a first configuration. The one or more processors can determine to identify a second configuration for the plurality of energy containers, one or more metrics of the first configuration as compared to a one or more criteria. The one or more processors can identify the second configuration of the plurality of energy containers, having one or more metrics which satisfy the one or more criteria. The one or more processors can modify a configuration of the plurality of energy containers to complete the operations within the worksite, from the first configuration to the second configuration.

A third aspect provided herein relate to a microgrid. The microgrid can include a plurality of energy containers to provide power to the microgrid according to an indication of demand for power to complete operations within a worksite. The microgrid can include a microgrid controller. The microgrid controller can include one or more processors coupled with memory. The one or more processors can receive from a microgrid, an indication of demand for power to complete operations within a worksite. The microgrid supplied with power from one or more of a plurality of energy containers in a first configuration. The one or more processors can determine to identify a second configuration for the plurality of energy containers, one or more metrics of the first configuration as compared to a one or more criteria. The one or more processors can identify the second configuration of the plurality of energy containers, having one or more metrics which satisfy the one or more criteria. The one or more processors can modify a configuration of the plurality of energy containers to complete the operations within the worksite, from the first configuration to the second configuration.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for configuring a microgrid, in accordance with present implementations.

FIG. 2 is a block diagram of a site level architecture using the system for configuring a microgrid, in accordance with present implementations.

FIG. 3 is a block diagram of a first configuration of energy containers, in accordance with present implementations.

FIG. 4 is a block diagram of a second configuration of energy containers, in accordance with present implementations.

FIG. 5 is another block diagram of the second configuration of energy containers, in accordance with present implementations.

FIG. 6 is another block diagram of a third configuration of energy containers, in accordance with present implementations.

FIG. 7 is a flowchart showing a method for configuring a microgrid, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement application specific battery configurations to control, remotely isolate, and remotely add energy containers based on the power demands of the microgrid. Furthermore, the systems and methods described herein can facilitate real-time (or near real-time) monitoring of parameters associated with the energy containers (e.g., environmental, electrical, demand, usage, runtime, and so forth) to allow adjustments to the configuration of energy containers. Incorrect or inefficient configurations for specific applications at the microgrid or at the worksite can decrease the lifespan of the energy containers, increase the chance of fault events (e.g., short circuit events), and reduce operations at the worksite, resulting in significant delays to the output of the worksite. According to the systems and methods described herein, a controller can use various inputs and calculations to remotely determine an optimal configuration associated with the application, demand for power, or electrical load of the microgrid without shutting down the microgrid to account for the change in configuration.

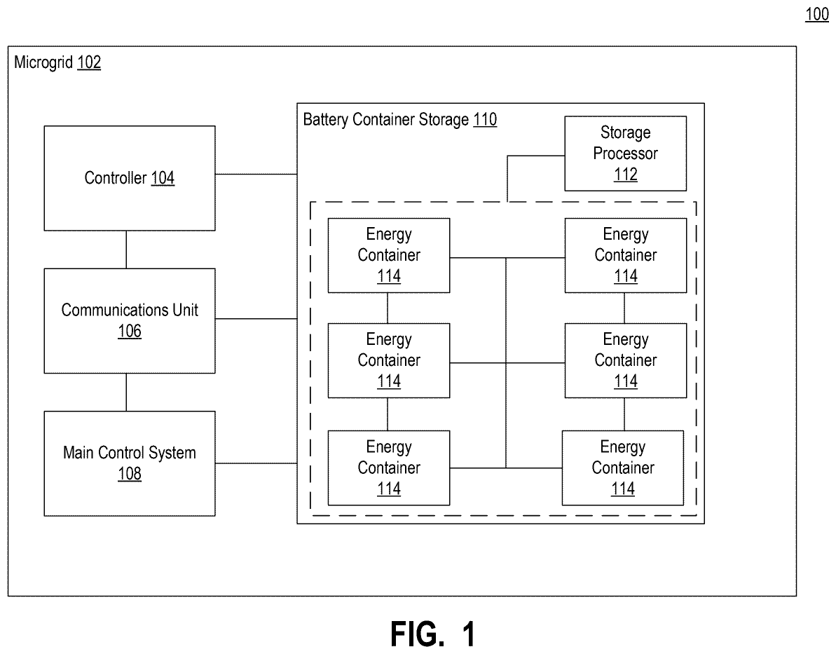

FIG. 1 is a block diagram of a system 100 for configuring a microgrid. The system 100 can include at least one microgrid 102. The microgrid 102 can include at least one microgrid controller 104 (e.g., hereinafter referred to as controller 104), at least one communications unit 106, at least one main control system 108, and at least one battery container storage 110. The microgrid 102 may be or include a localized or contained power grid dedicated for a particular region. The microgrid 102 may include at least one energy container 114 and various power sources which supply power to the microgrid 102 for distribution in the localized/contained area. For example, the microgrid 102 may include various types or forms of power sources, including utilities, generator sets, and renewable power sources. Various combinations of such power sources can supply power to the microgrid 102, to supply power to the localized/contained area (e.g., loads within the localized/contained area).

The power sources which supply power to the microgrid 102 may include utilities. The utilities may be or include a power source or connector corresponding to a utility line (e.g., a line/service drop from the power grid) supplying power generated for distribution across a wide power grid. The power of the utilities can be supplied by a power plant (e.g., solar power plant, hydroelectric power plant, or wind power plant, among others). The power plants can be owned or operated by an energy company, to supply power to the worksite or the microgrid 102.

The power sources which supply power to the microgrid 102 may include generator sets (referred to as “gensets” herein). The gensets may be located within close proximity to the microgrid 102, battery container storage 114 and/or areas of high power consumption. The gensets may include backup generators, distributed energy resources (DERs), or portable generators, among other elements/components/hardware.

The power sources which supply power to the microgrid 102 may include renewable energy sources (referred to as “renewables” herein). The renewables can include solar power, wind power, hydropower, geothermal power, wave energy, or biomass energy, communicably coupled to a power store configured to store power sourced from such renewable energy sources. The renewables can naturally generate power over time and are sustainable, and have a lower environmental impact. The renewables can receive energy from solar farms, wind turbines, water damns, geothermal power plants, or wave energy converters, among other elements/components/hardware. For example, a solar farm can supply power in the form of solar energy to the microgrid 102. In another example, wind turbines can supply power in the form of wind energy to the microgrid 102.

The controller 104 can include general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein (e.g., responsive to execution of instructions stored on memory [e.g., on-board, off-board, or cloud-based memory] accessible to the controller 104). The controller 104 can be or include a microcontroller. The controller 104 can be electrically coupled to the various components described herein to determine configurations for energy containers 114 within the worksite or the microgrid 102.

The communications unit 106 can be or include any device, component, element or hardware designed or configured to receive, transmit, or otherwise process signals exchanged between the components of the system 100. For example, the communications unit 106 may include various antennas, transceivers, modems, and associated control logic. The communications unit 106 may be configured to exchange wired and/or wireless signals according to various signaling protocols and on various types of networks. The communications unit 106 can be designed or configured to receive, transmit, or otherwise process signals from the components (e.g., controller 104, energy containers 114) to the main control system 108.

The main control system 108 can be a data center, a safety control room, a security control room, a site operations center, an IT control room, a command center, among other facilities to manage a worksite. The main control system 108 can house a plurality of computing devices or servers to receive signals transmitted by the communications unit 106. Each of the plurality of computing devices can be operated by a control room operator, a supervisor, a maintenance technician, a dispatcher, a security office, among other personnel, to monitor and manage the worksite, and/or to respond to the changing configurations of the energy containers 114.

The battery container storage 110 can include be or include an enclosure, a building, a storage unit, and the like, to house, store, or otherwise maintain a plurality of energy containers 114. The battery container storage 110 can include one or more pathways or conduits for electrical wiring and circuitry to interconnect each energy container 114 within the plurality of energy containers 114 using series and parallel connections. The battery container storage 110 can include at least one storage processor 112 and the plurality of energy containers 114.

The storage processor 112 can include general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein (e.g., responsive to execution of instructions stored on memory [e.g., on-board, off-board, or cloud-based memory] accessible to the storage processor 112). The controller 104 can be electrically coupled to the various components described herein to report information associated with each energy container 114 in the plurality of energy containers 114.

The energy containers 114 can be configured or designed to store energy generated from renewable energy sources (e.g., hydro, solar, wind, mechanical), and/or store energy generated from or provided by other energy sources (e.g., overflow power supplied by utilities, excess power generated by gensets, and so forth). The energy containers 114 can be configured to distribute power stored thereby, according to the demands of the microgrid 102. The energy containers 114 can utilize a plurality of energy storage systems, such as battery energy storage (e.g., Lithium-ion batteries, lead-acid batteries, Flow batteries, Nickel-cadmium), mechanical energy storage (e.g., pumped hydro, compressed air energy, flywheel energy), thermal energy storage (e.g., molten salt, ice, phase change), chemical energy (e.g., Hydrogen, Synthetic natural gas), among other types of energy.

The energy containers 114 can be interconnected in series and parallel through the plurality of coupler systems (described herein). By exploiting the series and parallel connections, the systems and methods described herein can isolate energy containers according to the changing demands of the worksite, without sacrificing the performance and efficiency of the worksite. Furthermore, interconnecting the energy containers 114 in series and in parallel can facilitate the site maintaining optimal efficiency distribution from energy containers, particularly where one or more of the energy containers performs subpar, to minimalize potential service interruptions and increase overall system efficiency/longevity.

The system 100 is not confined to the components described herein and can include additional or alternate components, not shown for brevity, which are to be considered within the scope of the embodiments described herein.

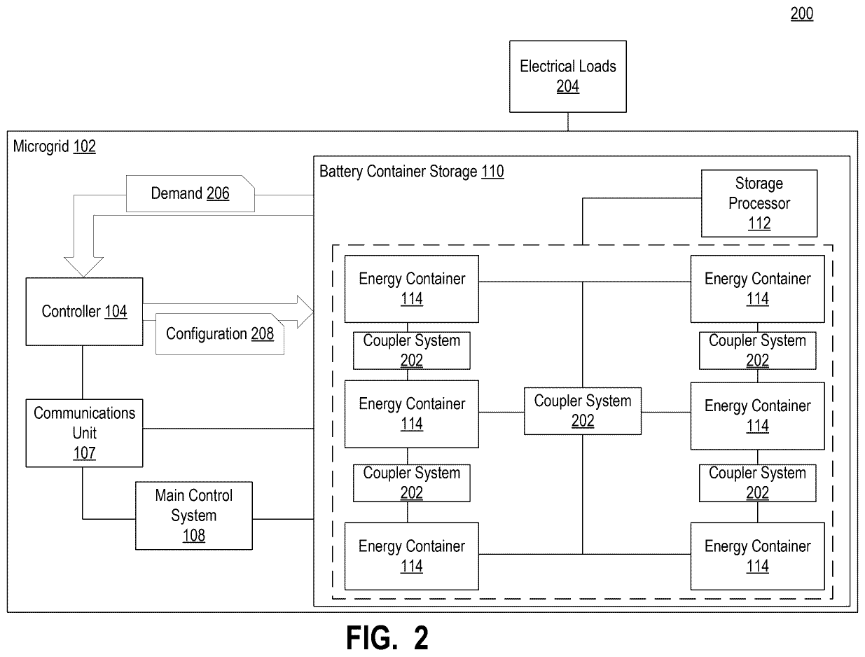

FIG. 2 is a block diagram of a worksite level architecture 200 using the system for configuring the microgrid 102. The site level architecture 200 can correspond to a physical layout of various renewables and power sources at a worksite. The physical layout can include a design or organization of the components, devices, machines, and connectivity of the components described herein. The site (or worksite) level architecture 200 can include at least one coupler system 202 within the battery container storage 110, and at least one electrical load 204 within the microgrid 102.

The coupler system 202 can be any mechanism, device, or hardware designed or configured to connect and disconnect attachments, circuits, busbars, electrical wires, substations, among other components/elements/hardware to electrical power between different sections of an electrical grid. The coupler system 202 can balance loads, isolate faults, and provide a continuous power supply for the system 100. The coupler system 202 can include at least one monitoring unit, at least one pre-charge circuit, at least one high voltage direct current (HVDC) contactor group, at least one pair of busbars, at least one direct current (DC) supply, and at least one communications unit 106. The coupler system 202 can facilitate connections between each energy container 114 in the plurality of energy containers 114. By using the coupler system 202, each energy container 114 can be electrically coupled by series and in parallel connections and enabling the removal or addition of at least one energy container to meet the demand for power.

The electrical load 204 can be any component, device, machine, or equipment that consumes electrical power within the site level architecture 200. For example, the electrical loads 204 can be drills, saws, grinders, transformers, sanders, generators, electrical vehicles, heavy machinery, among other components/elements/hardware. The electrical load 204 can convert electrical energy from a power transformer into other forms of energy (e.g., heat, lights, or mechanical motion). The electrical loads 204 can include resistive loads, inductive loads, capacitive loads, combination loads, among other components/elements/hardware.

Still referring to FIG. 2, the controller 104 can transmit, provide, or otherwise send a signal to each energy container 114 within the battery container storage 110. The signal can pre-configure the energy containers 114 according to the operations of the worksite 200. The signal can preconfigure the energy containers 114 based on cyclic aging balancing (e.g., cycling between energy containers 114 to distribute the electrical load 204 evenly to allow the energy containers 114 to age at a similar or comparable rate), calendar aging balancing (e.g., cycling between energy containers 114 such that each energy container maintains a similar or comparable lifespan), thermal balancing (e.g., cycling between energy containers based on temperature reported to the controller 104), prioritization (e.g., cycling between energy containers with higher priority), among other factors. For example, the controller 104 can pre-configure the energy containers 114 to have prioritization between each energy container 114. In another example, the controller 104 can pre-configure the energy containers 114 to have thermal balancing based on temperature feedback from each energy container 114 provided to the controller 104. In another example, the controller 104 can pre-configure the energy containers 114 to have cyclic ageing balancing. In another example, the controller 104 can pre-configure the energy containers 114 to have calendar ageing balancing.

The storage processor 112 can receive, obtain, or otherwise detect an indication of demand for power (hereinafter referred to as demand) from one or more electrical loads 204 to complete operations within the worksite 200 (e.g., excavation, concrete pouring, framing, material handling, construction, demolition, drilling, boring, cutting, shaping, lifting, access, paining, coating, surveying, among other operations). The demand for power can correspond with a requested amount of power from an electrical load 204. For example, an electric excavator can be charged to perform mining operations at the worksite 200. To complete the mining operations, the electric excavator can request power from the energy containers 114 at/within the battery container storage 110. In another example, an electric dump truck can transport heavy amounts of dirt, sand, gravel and the like. To transport the materials, the electric dump truck can request power from the energy containers 114 within the battery container storage 110 to complete the transportation operations. In another example, the worksite 200 can include a plurality of components operating on continuous electric power (e.g., lights electrically powered) can request continuous demand of power as part of mining operations. The demand for power can be a metric, a value, a threshold, among other elements/values/numbers, to indicate an amount of power needed to complete the operations within the worksite 200.

Prior to providing the power from the energy containers 114 to the electrical loads 204, the storage processor 112 can transmit the demand 206 to the controller 104. The storage processor 112 can be electrically connected to the one or more processors of the controller 104 to transmit and receive signals or indication of the demand 206. The indication or signal can be a variation in voltage, current, or electromagnetic waves, such as analog signals or digital signals, between the various components described above. For example, the storage processor 112 can transmit a signal to the controller 104 in response to the demand 206 from the electrical loads 204. The signal can indicate the demand 206, the type of electrical loads 204, the amount of available energy containers 114, the current configuration of the energy containers 114, the operation or application associated with the demand 206, the cyclic age of the energy containers 114, the calendar age of the energy of the energy containers 114, temperature, among other factors. For example, the signal can indicate that one or more electric machines request a demand 206 from the microgrid 102 to complete construction operations at the site 200. In another example, the signal can indicate that there are at least two energy containers 114 to satisfy the demand 206. In another example, the signal can indicate mining and quarrying operations associated with the demand 206 of the electrical loads 204.

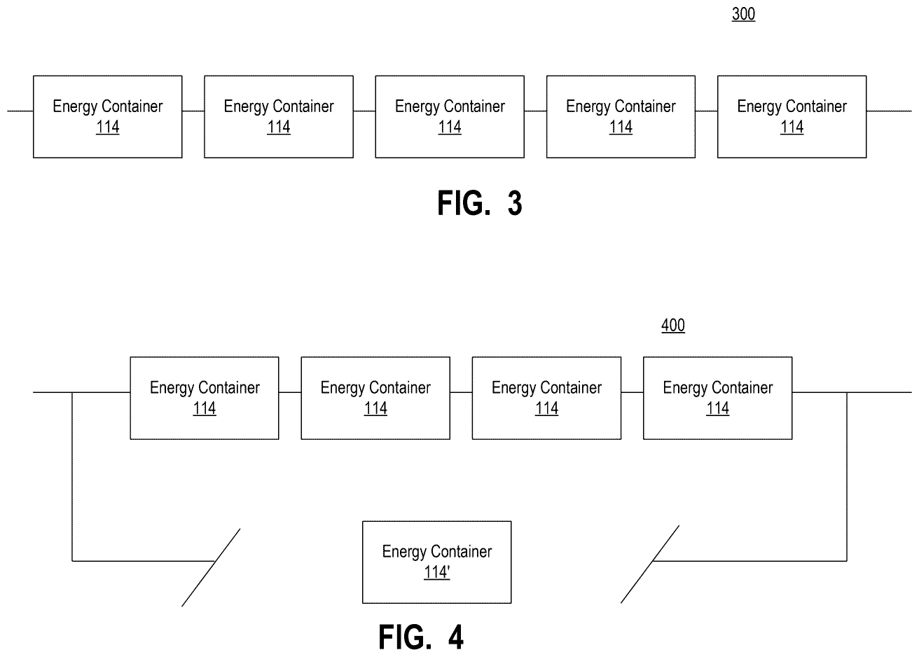

The controller 104 can receive the signal or the indication of the demand 206 from the microgrid 102 to complete operations within the worksite 200. Upon reception of the signal, the controller 104 can trigger the storage processor 112 to provide a first configuration of the plurality of energy containers that supply power to the microgrid 102. The first configuration can correspond an organization of each energy container 114 based on needs of the electrical load 204. For example, the microgrid 102 can include a first energy container 114, a second energy container 114, and third energy container 114. The configuration can indicate that the second energy container 114 is placed after the first energy container 114, but prior to the third energy container 114. FIG. 3 is a block diagram of the first configuration 300 of energy containers 114. The first configuration 300 is shown to include five energy containers, but it is understood that this is by example and the systems and methods described herein are not limited to the first configuration 300.

Concurrently, the storage processor 112 can report, track, or otherwise record one or more control parameters of each energy container 114 in the plurality of energy containers 114 to transmit to the controller 104 or the main control system 108. The one or more control parameters can include a state of charge, a state of health, a charge rate, a discharge rate, a temperature, voltage levels, current flow, cyclic age, calendar age, temperature, current configuration, opted configuration, kilowatt (KW), kilovolt-ampere reactive (KVAR), among other factors. To monitor each energy container 114, the storage processor 112 can receive the one or more control parameters from sensors attached to or otherwise arranged to monitor parameters of the energy containers 114. For example, the sensors of the energy container 114 can transmit the state of charge to the storage processor 112.

The communications unit 1106 can transmit, provide, or otherwise send data from the storage processor 112 to a computing device of the main control system 108. In operation, the storage processor 112 can start a data transmission to transmit data (e.g., control parameters) to the main control system 108. During the data transmission, the communications unit 106 can receive, retrieve, or otherwise obtain the data from the storage processor 112. Concurrently, the communications unit can store, house, buff, or otherwise maintain the data within a local storage (e.g., cache memory). Once the data transmission is complete, the communications unit 106 can provide, send, or otherwise transmit a packet/frame/information to the main control system 108 to display the control parameters on a user interface of the computing device. For example, the communications unit 106 can provide the state of charge and the charge rate for the energy containers as data within the user interface of a computing device associated with the main control system 108.

The controller 104 can detect, calculate, or otherwise determine to identify a second configuration for the plurality of energy containers 114. The second configuration can correspond to an organization of each energy container 114 based on the demand 206 of the electrical load 204, while adding or removing at least one energy container 114 from microgrid 102 within the worksite 200. The second configuration can differ from the first configuration 300 by including one or more energy containers 114 than the first configuration 300. For example, the first configuration 300 can include 3-5 energy containers 114, whereas the second configuration can include 6-7 energy containers 114. The second configuration can differ from the first configuration 300 by excluding one or more energy containers 114 than the first configuration 300. For example, the first configuration 300 can include 7-9 energy containers 114, whereas the second configuration can include 3-5 energy containers 114.

The controller 104 can compare, evaluate, or otherwise analyze one or more metrics (e.g., the one or more control parameters of each energy container 114) of the first configuration against a one or more criteria to determine to identify the second configuration for the plurality of energy containers 114. The controller 104 can determine, calculate, or otherwise identify the one or more criteria by using the indication of the demand 206. For example, the controller 104 can use the demand 206 can specify a minimum amount of power to complete the operations within the worksite 200 (e.g., one or more criteria). The one or more criteria can identify one or more factors, specifications, requirements, or a threshold to meet the minimum performance to complete the operations of the worksite 200. The one or more criteria can include voltage requirements (e.g., output voltage and input voltage), current ratings (e.g., minimum current to complete operations at the worksite 200), power ratings (e.g., total power to exceed the demand 206), efficiency rating (e.g., minimum efficiency to reduce waste), mean time between failures (MTBF), minimum power to be a power source, minimum energy to be an energy source, prioritization of battery containers, thermal balancing, cyclic ageing balancing, calendar aging balancing, among other criteria. For example, the controller 104 can compare the output voltage of the first configuration 300 with the output voltage of the power supply requirement according to the demand 206 of the electrical load 204 to identify that the plurality of energy containers 114 in the first configuration 300 satisfy the one or more criteria. In another example, the controller 104 can compare the power rating of the first configuration 300 with the power rating of the power supply requirement according to the demand 206 of the electrical load 204 to identify that the plurality of energy containers 114 in the first configuration 300 satisfy the one or more criteria.

In response to the first configuration 300 satisfying the one or more criteria (e.g., above the minimum amount of power to complete the operations within the worksite 200), the controller 104 can calculate, generate, or otherwise determine a plurality of configurations 208 to increase the lifespan of each energy container 114 within the plurality of energy containers 114. For example, the controller 104 can calculate configurations to increase the lifespan of the energy container 114 with the greatest calendar age by isolating the respective energy container 114. In another example, the controller 104 can calculate configurations to increase the lifespan of the energy container 114 with the greatest cyclic age by isolating the respective energy container 114. In another example, the controller 104 can calculate configurations to increase the lifespan of the energy container 114 with the greatest temperature feedback by isolating the respective energy container 114. In another example, the controller 104 can calculate configurations to increase the lifespan of the energy container 114 with the lowest priority by isolating the respective energy container 114. In another example, the controller 104 can calculate configurations according to the indication of power and the one or more criteria (e.g., thermal balancing, cyclic ageing balancing, calendar ageing balancing).

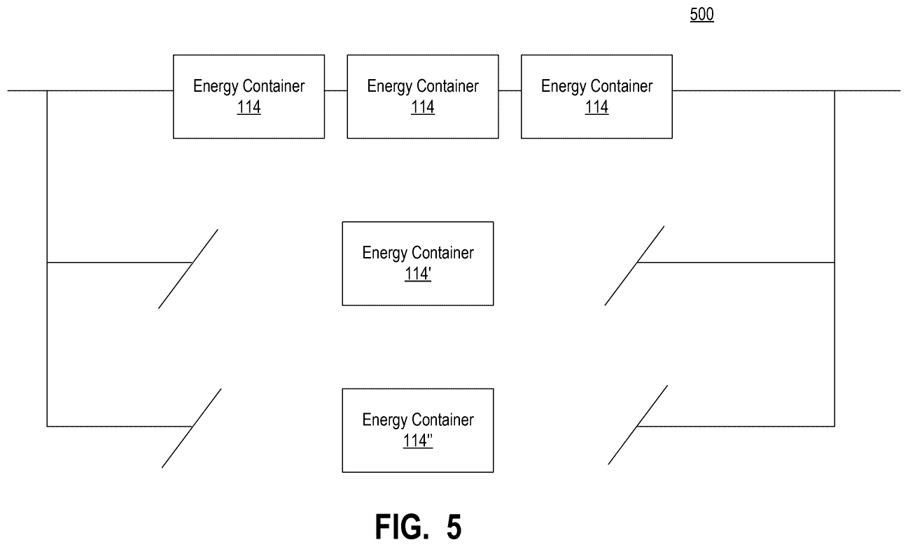

In response to the first configuration 300 not satisfying the one or more criteria, the controller 104 can calculate, generate, or otherwise determine one or more other configurations 208 to satisfy the one or more criteria. For example, the controller 104 can calculate a first configuration, a second configuration, and/or a third configuration for the energy containers 114. Each of the configurations 208 can satisfy one or more aspects of the one or more criteria in accordance with the demand 206 of the electrical load 204. From here, the controller 104 can identify either the first configuration, the second configuration, or the third configuration for the energy containers 114 to complete the operations at the worksite 200. FIG. 4 and FIG. 5 are block diagrams of the second configuration to satisfy the one or more criteria. As shown in FIG. 4, the second configuration 400 can include one excluded energy container 114′ to satisfy the one or more criteria. As shown in FIG. 5, the second configuration 500 can include two isolated energy containers 114.

Continuing on, the controller 104 can calculate, generate, or otherwise determine the plurality of configurations 208, according to the one or more control parameters, to satisfy the one or more criteria. For example, the controller 104 can calculate a first configuration, a second configuration, and a third configuration for the energy containers 114. Each of the configurations 208 can satisfy one or more aspects of the one or more criteria. However, using the one or more control parameters or the one or more metrics of each energy container 114 within the microgrid 102, some configurations 208 can maximize on the one or more control parameters in accordance with the demand 206. For example, the calendar age of a first energy container 114′ can be higher than the calendar age of the rest of the energy containers 114 within the battery container storage 110. When calculating the plurality of configurations 208, at least one configuration 208 can remove the first energy container 114′, as shown in FIG. 4. By removing the first energy container 114′, the controller 104 can increase one or more control parameters (e.g., output voltage, power output, current) of the non-isolated energy containers 114 to satisfy the one or more criteria. In this manner, the controller 104 can maximize on the lifespan of the first energy container 114′ by removing the first energy container 114′ while the one or more criteria is met using the non-isolated energy containers 114.

The controller 104 can identify, determine, or otherwise select the configuration 208 (e.g., second configuration, third configuration, fourth configuration, etc.) for the plurality of energy containers 114. The identified configuration 208 can satisfy the one or more criteria and provide an optimum utilization for each energy container 114 within the microgrid 102. For example, the controller 104 can calculate the plurality of configurations 208 to satisfy the one or more criteria while maximizing on the one or more control parameters of each energy container 114 within the microgrid 102. From here, the controller 104 can identify the configuration 208 that improves the lifespan of the energy containers 114 based on cyclic ageing balancing. In another example, controller 104 can identify the configuration 208 that improves the lifespan of the energy containers 114 based on calendar ageing balancing. In another example, controller 104 can identify the configuration 208 that improves the lifespan of the energy containers 114 based on thermal balancing. In another example, controller 104 can identify the configuration 208 that improves the lifespan of the energy containers 114 based on prioritization between the energy containers 114.

Once the configuration 208 is identified, the controller 104 can transmit, send, or other provide the configuration 208 to the main control system using the communications unit 106. The communications unit 106 can provide the configuration 208 on the user interface of a computing device associated with the main control system 108. Personnel of the main control system 108 (e.g., technician, worker, IT, administrator, manager) can review the configuration 208 according to the one or more control parameters of each energy container 114 within the configuration 208. In some cases, the main control system 108 can transmit a response to the configuration 208. Upon reception of the response, the controller 104 can apply the configuration 208 to the energy containers 114. For example, the response can approve of the identified configuration 208, thereby, causing the controller 104 to modify the configuration 208 to the identified configuration 208. In another example, the response can deny the identified configuration 208. Therefore, the controller 104 can recalculate the plurality of configurations of the energy containers 114 to satisfy the one or more criteria. In this manner, the microgrid 102 can continuously calculate the optimal configuration 208 for the operations at the worksite 200 without the need to shut down the entire microgrid 102 to adjust the configuration of the energy containers 114. However, in some instances, the controller 104 can automatically modify the configuration 208 without any review/acceptance/denial from the personnel of the main control system 108. By automatically modifying the configuration 208, the controller 104 can complete operations of the worksite 200 faster and more efficiently.

The controller 104 can modify the configuration 208 of the energy containers 114 from the first configuration 300 to the identified configuration 208 (e.g., second configuration 400, second configuration 500, third configuration, etc.) to complete operations within the worksite 200. For example, the controller 104 can modify the configuration 208 of the energy containers 114 from the first configuration 300 to the second configuration 400 to complete operations within the worksite 200. In another example, the controller 104 can modify the configuration 208 of the energy containers 114 from the first configuration 300 to the second configuration 500 to complete operations within the worksite 200. In another example, the controller 104 can modify the configuration 208 of the energy containers 114 from the second configuration 400 to the second configuration 500 to complete operations within the worksite 200. In another example, the controller 104 can modify the configuration 208 of the energy containers 114 from the second configuration 500 to the first configuration 300 to complete operations within the worksite 200.

To modify the configuration 208, the controller 104 can remove, isolate, or otherwise disconnect at least one energy container 114 from the plurality of energy containers 114 by causing the storage processor 112 to adjust a plurality of contactors within a contactor group of the coupler system 202. For instance, by adjusting a plurality of contactors within the contactor group, the coupler system 202 can disconnect electrical energy provided by the DC supply and the pre-charge circuit, thereby, decoupling electrical energy from the busbar. Once decoupled, the busbar cannot conduct electrical energy through the coupler system 202, therefore, isolating at least one energy container 114 connected to the coupler system 202 from the configuration 208. Since the energy containers 114 are configured for coupling in series and in parallel connections through the coupler system 202, the storage processor 112 can cause the respective coupler system 202 to isolate at least one energy container 114 according to the demand 206 to improve the lifespan of the isolated at least one energy container 114. As a result of isolating the energy container 114 to improve the lifespan, the microgrid 102 can transition from, for example, the first configuration 300, as shown in FIG. 3, to the second configuration 400 as shown in FIG. 4. Accordingly, the systems and methods described herein facilitate the controller 104 leveraging the one or more series-parallel connections between each energy container 114 by selectively connecting the energy containers in the one or more series-parallel connections, to modify the configuration 208 according to various operational parameters or other metrics.

Once the energy containers 114 are in the modified configuration 208, the controller 104 can, for example, adjust a voltage of the non-isolated energy containers 114 at the site 200 to operate above an operational threshold. The operational threshold can be or include a minimum power output of the non-isolated energy containers 114 to satisfy the demand 206 of the electrical load 204 or the one or more criteria. While the energy containers 114 are in the previous configuration (e.g., first configuration 300, second configuration 400, etc.), the energy containers 114 can be configured to operate at the operational threshold according to the demand 206 of the electrical load 204 or the one or more criteria. However, upon isolation of the at least one energy container 114, the non-isolated energy containers 114 may need to increase the one or more control parameters to operate at the operational threshold at the site 200 to satisfy the demand 206 of the electrical load 204. Therefore, the controller 104 can calculate a rate to adjust the one or more control parameters to maintain the operational threshold. For example, the controller 104 can double the voltage of the non-isolated energy containers 114 to satisfy the demand 206 of the electrical load 204.

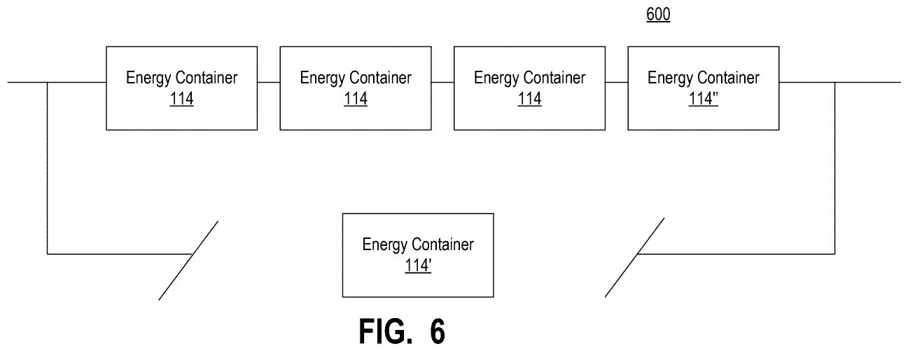

In another instance, by adjusting a plurality of contactors within the contactor group, the coupler system 202 can connect electrical energy provided by the DC supply and the pre-charge circuit, thereby, coupling electrical energy with the busbar. Once coupled, the busbar can conduct electrical energy through the coupler system 202, therefore, adding at least one energy container 114 connected to the coupler system 202 to the configuration 208. Since the energy containers 114 are configured for coupling in series and/or in parallel through the coupler system 202, the storage processor 112 can cause the respective coupler system 202 to add the at least one energy container 114 according to the demand 206 of the electrical load 204. As a result of adding the energy container 114 to meet the demand 206 of the electrical load 204, the microgrid 102 can transform/switch/transition from, for example, the second configuration 500, as shown in FIG. 5, to a third configuration 600 as shown in FIG. 6.

Once the energy containers 114 are in the modified configuration 208, the controller 104 can, for example, adjust a voltage of the energy containers 114 at the site 200 to operate above the operational threshold. While the energy containers 114 are in the previous configuration (e.g., first configuration 300, second configuration 400, etc.), the energy containers 114 can be configured to operate at the operational threshold according to the demand 206 of the electrical load 204. However, in response to an increase in demand 206 of the electrical load 204, the energy containers 114 may need to increase the one or more control parameters to operate at the operational threshold at the site 200 to satisfy the demand 206 of the electrical load 204. Therefore, the controller 104 can calculate a rate to adjust the one or more control parameters to maintain the operational threshold. For example, the controller 104 can double the voltage of the energy containers 114 to satisfy the demand 206 of the electrical load 204.

In some instances, the modified configuration 208 can add at least one isolated/non-included energy container 114 to the set of non-isolated energy containers 114. The controller 104 can trigger the respective coupler system 202 to use the pre-charge circuit to charge the at least one isolated energy container 114. While charging, the storage processor 112 can monitor the one or more control parameters of the at least one isolated energy container 114 to determine whether the isolated energy container 114 can operate in accordance with the non-isolated energy containers 114. For example, the modified configuration 208 can add a first energy container 114 to a set of non-isolated energy containers 114. Before adding the first energy container 114, the controller 104 can trigger a first coupler system 202 to charge the first energy container 114 to meet the demand 206 of the electrical load 204. From here, the storage processor 112 can determine whether the first energy container 114 can operate within the set of non-isolated energy containers 114 based on the first energy container 104 and the set of non-isolated energy containers 114 satisfying the operational threshold.

Concurrently, the controller 104 can trigger the set of non-isolated energy containers 114 to reduce the amount of voltage/power supplied to the electrical loads 204 to allow the at least one isolated energy container 114 to compensate for the power reduction. For example, the first configuration can include a first energy container 114, a second energy container 114, and a third energy container 114. Each energy container can supply power to meet the demand 206 of the electrical load 204 by dividing the total power to meet the demand 206 by the number of energy containers 114 within the configuration

$$( e . g . , \frac{180 MW Hr}{3 Energy Containers} = 60 \frac{MW Hr}{Energy Container} ) .$$

The modified configuration 208 can introduce a fourth energy container 114, therefore, each energy container 114 can supply power to me the demand at a rate of the total power divided by the number of energy containers

$$( e . g . , \frac{180 MW Hr}{4 Energy Containers} = 45 \frac{MW Hr}{Energy Container} ) .$$

Furthermore, the controller 104 can charge the fourth energy container 114 while reducing the power supplied to the electrical loads 204 by the first energy container 114, the second energy container 11, and the third energy container 114.

Upon operating within the modified configuration 208, the storage processor 112 can receive, obtain, or otherwise detect a second indication of demand 206 from the one or more electrical loads 204 to complete different operations within the worksite 200. For example, the first indication of demand 206 can correspond to mining operations at the worksite 200, whereas the second indication of demand 206 can correspond to excavation operations at the worksite 200. For example, at a first time, an electric excavator can perform mining operations at the worksite 200, thereby, requesting power from the energy containers 114 at within the battery container storage 110 to complete the mining operations. At a second time, an electric bulldozer can perform demolition operations at the worksite 200, thereby, requesting power from the energy containers 114 at within the battery container storage 110 to complete the demolition operations.

Prior to providing the power from the energy containers 114 to the electrical loads 204, the storage processor 112 can transmit the demand 206 to the controller 104. The storage processor can transmit and receive signals or the second indication of the demand 206. For example, the storage processor 112 can transmit a second signal to the controller 104 in response to the demand 206 from the electrical loads 204. The signal can indicate the demand 206, the type of electrical loads 204, the amount of available energy containers 114, the current configuration (e.g., second configuration 400) of the energy containers 114, the operation or application associated with the demand 206, the cyclic age of the energy containers 114, the calendar age of the energy of the energy containers 114, temperature, among other factors. For example, the signal can indicate that one or more electric machines request a demand 206 from the microgrid 102 to complete construction operations at the site 200. In another example, the signal can indicate that there are at least two energy containers 114 to satisfy the demand 206. In another example, the signal can indicate mining and quarrying operations associated with the demand 206 of the electrical loads 204.

The controller 104 can receive the second signal or the indication of the demand 206 from the storage processor 112 to complete operations within the worksite 200. Upon reception of the second signal, the controller 104 can trigger the storage processor 112 to provide the current configuration of the plurality of energy containers that supply power to the microgrid 102. The current configuration can correspond an organization of each energy container 114 based on the previous demand 206 of the electrical load 204. For example, the microgrid 102 can include a first energy container 114, a second energy container 114, and third energy container 114. The configuration can indicate that the second energy container 114 is placed after the first energy container 114, but prior to the third energy container 114.

The controller 104 can detect, calculate, or otherwise determine to identify a third configuration for the plurality of energy containers 114. The third configuration can correspond to an organization of each energy container 114 based on the second demand 206 of the electrical load 204, while adding or removing at least one energy container 114 from microgrid 102 within the worksite 200. The third configuration can differ from the second configuration 400 by including one or more energy containers 114 than the second configuration 400. For example, the second configuration 400 can include 3-5 energy containers 114, whereas the third configuration can include 6-7 energy containers 114. The third configuration can differ from the second configuration 400 by excluding one or more energy containers 114 than the second configuration 400. For example, the second configuration 400 can include 7-9 energy containers 114, whereas the third configuration can include 3-5 energy containers 114.

The controller 104 can compare, evaluate, or otherwise analyze the second configuration to with another one or more criteria (e.g., thermal balancing, cyclic ageing balancing, calendar ageing balancing, priority) to determine to identify the second configuration for the plurality of energy containers 114. The controller 104 can determine, calculate, or otherwise identify the one or more criteria by using the second indication of the demand 206. For example, the controller 104 can use the second demand 206 can specify a minimum amount of power to complete the operations within the worksite 200 (e.g., one or more criteria). The one or more criteria can identify one or more factors, specifications, requirements, or a threshold to meet the minimum performance to complete the operations of the worksite 200. The one or more criteria can include voltage requirements (e.g., output voltage and input voltage), current ratings (e.g., minimum current to complete operations at the worksite 200), power ratings (e.g., total power to exceed the demand 206), efficiency rating (e.g., minimum efficiency to reduce waste), mean time between failures (MTBF), minimum power to be a power source, minimum energy to be an energy source, prioritization of battery containers, thermal balancing, cyclic ageing balancing, calendar aging balancing, among other criteria. For example, the controller 104 can compare the output voltage of the second configuration with the output voltage of the power supply requirement according to the second demand 206 of the electrical load 204 to identify that the plurality of energy containers 114 in the second configuration to satisfy the one or more criteria. In another example, the controller 104 can compare the power rating of the second configuration with the power rating of the power supply requirement according to the second demand 206 of the electrical load 204 to identify that the plurality of energy containers 114 in the second configuration to satisfy the one or more criteria.

In response to the second configuration satisfying the one or more criteria (e.g., above the minimum amount of power to complete the operations within the worksite 200), the controller 104 can calculate, generate, or otherwise determine a plurality of configurations 208 to increase the lifespan of each energy container 114 within the plurality of energy containers 114 of the second configuration. For example, the controller 104 can calculate configurations to increase the lifespan of the energy container 114 with the greatest calendar age by isolating the respective energy container 114. In another example, the controller 104 can calculate configurations to increase the lifespan of the energy container 114 with the greatest cyclic age by isolating the respective energy container 114. In another example, the controller 104 can calculate configurations to increase the lifespan of the energy container 114 with the greatest temperature feedback by isolating the respective energy container 114. In another example, the controller 104 can calculate configurations to increase the lifespan of the energy container 114 with the lowest priority by isolating the respective energy container 114.

In response to the second configuration not satisfying the one or more criteria, the controller 104 can calculate, generate, or otherwise determine a plurality of configurations 208 to satisfy the one or more criteria. For example, the controller 104 can calculate a first configuration, a second configuration, and a third configuration for the energy containers 114. Each of the configurations 208 can satisfy one or more aspects of the one or more criteria in accordance with the second demand 206 of the electrical load 204. From here, the controller 104 can identify either the first configuration, the second configuration, or the third configuration for the energy containers 114 to complete the operations at the worksite 200 as shown in FIGS. 4-6.

Continuing on, the controller 104 can calculate, generate, or otherwise determine the plurality of configurations 208, according to the one or more control parameters, to satisfy the one or more criteria. For example, the controller 104 can calculate a first configuration, a second configuration, and a third configuration for the energy containers 114. Each of the configurations 208 can satisfy one or more aspects of the one or more criteria. However, using the one or more control parameters of each energy container 114 within the microgrid 102, some configurations 208 can maximize on the one or more control parameters in accordance with the second demand 206. For example, the calendar age of a first energy container 114′ can be higher than the calendar age of the rest of the energy containers 114 within the battery container storage 110. When calculating the plurality of configurations 208, at least one configuration 208 can remove the first energy container 114′, as shown in FIG. 4. By removing the first energy container 114′, the controller 104 can increase the one or more control parameters (e.g., output voltage, power output, current) of the non-isolated energy containers 114 to satisfy the one or more criteria. In this manner, the controller 104 can maximize on the lifespan of the first energy container 114′ by removing the first energy container 114′ while the one or more criteria is met using the non-isolated energy containers 114.

The controller 104 can identify, determine, or otherwise select the configuration 208 (e.g., second configuration, third configuration, fourth configuration, etc.) for the plurality of energy containers 114. The identified configuration 208 can satisfy the one or more criteria and provide an optimum utilization for each energy container 114 within the microgrid 102. For example, the controller 104 can calculate the plurality of configurations 208 to satisfy the one or more criteria while maximizing on the one or more control parameters of each energy container 114 within the microgrid 102. From here, the controller 104 can identify the configuration 208 that improves the lifespan of the energy containers 114 based on cyclic ageing balancing. In another example, controller 104 can identify the configuration 208 that improves the lifespan of the energy containers 114 based on calendar ageing balancing. In another example, controller 104 can identify the configuration 208 that improves the lifespan of the energy containers 114 based on thermal balancing. In another example, controller 104 can identify the configuration 208 that improves the lifespan of the energy containers 114 based on prioritization between the energy containers 114. In some instances, the identified configuration 208 can be the same as the previous configuration (e.g., first configuration 300, second configuration 400, second configuration 500). For example, if the previous configuration is the second configuration 500, the identified configuration 208 can be the third configuration 600. The third configuration 600 can add an energy container 114″ into the set of non-isolated energy container 114 while maintain the energy container 114′ in isolation. In this manner, the third configuration 600 can be the same as the second configuration 400.

The controller 104 can modify the configuration 208 of the energy containers 114 from the first configuration 300 to the identified configuration 208 (e.g., second configuration 400, second configuration 500, third configuration 600, etc.) to complete operations within the worksite 200. For example, the controller 104 can modify the configuration 208 of the energy containers 114 from the first configuration 300 to the second configuration 400 to complete operations within the worksite 200. In another example, the controller 104 can modify the configuration 208 of the energy containers 114 from the first configuration 300 to the second configuration 500 to complete operations within the worksite 200. In another example, the controller 104 can modify the configuration 208 of the energy containers 114 from the second configuration 400 to the second configuration 500 to complete operations within the worksite 200. In another example, the controller 104 can modify the configuration 208 of the energy containers 114 from the second configuration 500 to the first configuration 300 to complete operations within the worksite 200.

To modify the configuration 208, the controller 104 can remove, isolate, or otherwise disconnect at least one energy container 114 from the plurality of energy containers 114 by causing the storage processor 112 to adjust a plurality of contactors within a contactor group of the coupler system 202. For instance, by adjusting a plurality of contactors within the contactor group, the coupler system 202 can disconnect electrical energy provided by the DC supply and the pre-charge circuit, thereby, decoupling electrical energy from the busbar. Once decoupled, the busbar cannot conduct electrical energy through the coupler system 202, therefore, isolating at least one energy container 114 connected to the coupler system 202 from the configuration 208. Since the energy containers 114 are configured for coupling in series and in parallel through the coupler system 202, the storage processor 112 can cause the respective coupler system 202 to isolate at least one energy container 114 according to the demand 206 to improve the lifespan of the isolated at least one energy container 114. As a result of isolating the energy container 114 to improve the lifespan, the microgrid 102 can transition from, for example, the first configuration 300, as shown in FIG. 3, to the second configuration 400 as shown in FIG. 4.

Once the energy containers 114 are in the modified configuration 208, the controller 104 can, for example, adjust a voltage of the non-isolated energy containers 114 at the site 200 to operate above an operational threshold. The operational threshold can show a minimum power output of the non-isolated energy containers 114 to satisfy the demand 206 of the electrical load 204 or the one or more criteria. While the energy containers 114 are in the previous configuration (e.g., first configuration 300, second configuration 400, etc.), the energy containers 114 can be configured to operate at the operational threshold according to the second demand 206 of the electrical load 204 or the one or more criteria. However, upon isolation of the at least one energy container 114, the non-isolated energy containers 114 may need to increase the one or more control parameters to operate at the operational threshold at the site 200 to satisfy the second demand 206 of the electrical load 204. Therefore, the controller 104 can calculate a rate to adjust the one or more control parameters to maintain the operational threshold. For example, the controller 104 can double the voltage of the non-isolated energy containers 114 to satisfy the demand 206 of the electrical load 204.

In another instance, by adjusting a plurality of contactors within the contactor group, the coupler system 202 can connect electrical energy provided by the DC supply and the pre-charge circuit, thereby, coupling electrical energy with the busbar. Once coupled, the busbar can conduct electrical energy through the coupler system 202, therefore, adding at least one energy container 114 connected to the coupler system 202 to the configuration 208. Since the energy containers 114 are configured for coupling in series and in parallel through the coupler system 202, the storage processor 112 can cause the respective coupler system 202 to add the at least one energy container 114 according to the demand 206 of the electrical load 204. As a result of adding the energy container 114 to meet the demand 206 of the electrical load 204, the microgrid 102 can transform from, for example, the second configuration 500, as shown in FIG. 5, to a third configuration 600 as shown in FIG. 6.

Once the energy containers 114 are in the modified configuration 208, the controller 104 can, for example, adjust a voltage of the energy containers 114 at the site 200 to operate above the operational threshold. While the energy containers 114 are in the previous configuration (e.g., first configuration 300, second configuration 400, etc.), the energy containers 114 can be configured to operate at the operational threshold according to the demand 206 of the electrical load 204. However, in response to an increase in demand 206 of the electrical load 204, the energy containers 114 may need to increase the one or more control parameters to operate at the operational threshold at the site 200 to satisfy the demand 206 of the electrical load 204. Therefore, the controller 104 can calculate a rate to adjust the one or more control parameters to maintain the operational threshold. For example, the controller 104 can double the voltage of the energy containers 114 to satisfy the demand 206 of the electrical load 204.

### INDUSTRIAL APPLICABILITY

The disclosed embodiments may be applicable to any grid, microgrid, or power distribution based system or solution. For example, the disclosed embodiments may be applicable to or applied to a worksite, such as a construction site, mining operations, drilling sites, a power plant, renewable energy sources, transmission towers, relays, a power source for a home, a power source for the office, or any other residential/industrial setting, or any other power delivery system which may adjust configurations of a plurality of energy containers according to an application or operation. The disclosed embodiments may be applicable to electrical system which use or include High Voltage Direct Current (HVDC) bus coupling, or HVDC systems which control each energy container at the site level, and to remotely actuate and/or configure the coupling mechanisms between energy containers as per system requirements. The disclosed controller 116 can be provided to efficiently control and optimize the energy containers at the site level for specific operations by modifying the configuration of the energy containers by using a plurality of contactors within a HVDC contactor group. For example, the controller 116 can open one or more contactors within the contactor group to decouple and couple an energy container to satisfy a demand from power from various electrical loads.

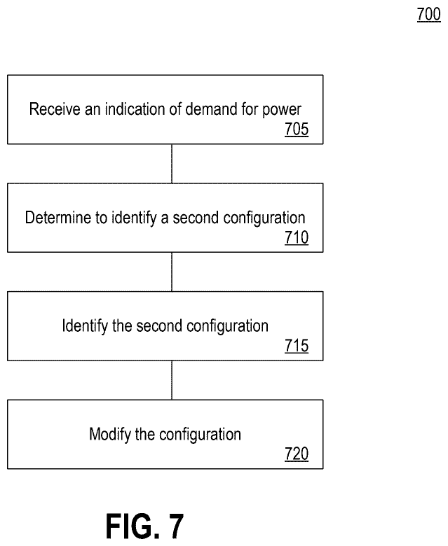

Referring now to FIG. 7, depicted is a flowchart showing an example method 700 of configuring a microgrid (e.g., microgrid 102). The method 700 may be performed by, implemented on, or otherwise executed by the components, elements, or hardware described above with reference to FIGS. 1-6. For example, the method 700 may be executed by the components of FIG. 1 and FIG. 2. As a brief overview, at step 705, the controller 104 can receive an indication of demand for power. At step 710, the controller 104 can determine to identify a second configuration. At step 715, the controller 104 can identify the second configuration of a plurality of energy containers. At step 720, the controller 104 can modify the configuration.

At step 705, the controller 104 can receive an indication of demand for power for a plurality of energy containers 114 in a first configuration. The storage processor 112 can transmit the indication of demand for power to operations within the worksite 200 associated with electrical loads 204, such as drills, saws, grinders, transformers, sanders, generators, electrical vehicles, heavy machinery, among other components/elements/hardware, which require an amount of power to complete the operations. The demand for power can fluctuate according to the respective operation at the worksite 200. In some instances, the controller 104 can pre-configure each energy container 114 within the battery container storage 110 to complete an initial operation at the worksite 200. The storage processor 112 can provide data that includes one or more control parameters of each energy container 114 to a communications unit 106. The communications unit 106 can provide the data to a user interface of a computing device associated with the main control system 108.

At step 710, the controller 104 can determine to identify a second configuration of the plurality of energy containers. The second configuration (sometimes referred to as an identified configuration) of the plurality of energy containers 114 can differ from the first configuration of the plurality of energy containers 114. The controller 104 can calculate one or more criteria based on the demand for power from the electrical loads 204. The one or more criteria can be a minimum amount of power to complete the operations at the worksite 200, minimum power to be a power source, minimum energy to be an energy source, prioritization of battery containers, thermal balancing, cyclic ageing balancing, calendar aging balancing. Upon calculating the one or more criteria, the controller 104 can identify that the first configuration of the plurality of energy containers 114 satisfies the one or more criteria by comparing the one or more control elements of each energy container 114 to the aspects of the one or more criteria.

If one or metrics of the first configuration of the plurality of energy containers does not satisfy the one or more criteria, at step 715, the controller 104 can identify the second configuration of the plurality of energy containers 114. The controller 104 can use the demand and the one or more control parameters (e.g., one or more metrics) of each energy container, to calculate, identify, or otherwise determine one or more configurations to satisfy the one or more criteria. Each calculated configuration can differ from the first configuration. Upon completion of determining the configuration(s) for the plurality of energy containers 114, the controller 104 can use the one or more control parameters to select at least one configuration to maximize the lifespan of each energy container while satisfying the one or more criteria. The controller can transmit the identified configuration of the plurality of energy containers 114 to the main control system 108. In some embodiments, the controller can receive a response indicating an approval or a denial of the identified configuration of the plurality of energy containers 114.

At step 720, the controller 104 can modify the configuration of the plurality of energy containers from the first configuration to the modified configuration, to complete the operations within the worksite 200. The controller 104 can transmit a signal to the storage processor 112. The signal can include the identified configuration for the plurality of energy containers. The reception of the signal by the storage processor 112 can trigger the storage processor 112 to use a plurality of contactors within a contactor group of a coupler system 202 to remove and/or add energy containers 114 to the first configuration to achieve the identified configuration. To modify the configuration, the storage processor 112 can use the signal from the controller 104 to selectively connect the energy containers 114 in one or more series or parallel connections. Once the energy containers are connected to for the identified configuration, the controller 104 can calculate a rate to adjust the one or more control parameters of each energy container within the second configuration to satisfy the demand for power.

If the first configuration satisfies the power demand, the controller 104 can wait for a subsequent demand from the electrical loads 204 to repeat the method 700 again. In this manner, the controller 104 can remotely reconfigure the plurality of energy containers 114 to satisfy demands of a plurality of operations within the worksite 200 by continuously changing the one or more series-parallel connections of each energy container 114.

By using the systems and methods described herein to control the energy containers, the worksite 200 can benefit from an improved efficient use of each energy container by exploiting the one or more series-parallel connections to satisfy the demand for power. Using the system and methods described herein, the controller can intelligently maximize on the lifespan of each energy container by prioritizing cyclic age balancing, calendar age balancing, and thermal balancing during each operation within the worksite. Furthermore, the systems and methods described herein, remove the need for manual intervention when the operations of the worksite change, thereby saving time to reconfigure the plurality of energy containers, reducing cost at the worksite, and reducing completion time of large scale projects. Overall, the systems and methods described herein provide improvement to the management and control of energy containers at a worksite.

What is claimed is:

1. A method of configuring a microgrid, comprising:
receiving, by a controller from the microgrid, an indication of demand for power to complete operations within a worksite, the microgrid supplied with power from one or more of a plurality of energy containers in a first configuration;
determining, by the controller, to identify a second configuration for the plurality of energy containers, based on one or more first metrics of the first configuration as compared to one or more criteria;
identifying, by the controller, the second configuration of the plurality of energy containers, having one or more second metrics which satisfy the one or more criteria; and
modifying, by the controller, a configuration of the plurality of energy containers to complete the operations within the worksite, from the first configuration to the second configuration.

2. The method of claim 1, wherein each energy container of the plurality of energy containers are selectively connected in series and in parallel via a coupler system, and wherein the configuration is modified by selectively connecting each energy containers in one or more series-parallel connections.

3. The method of claim 1, further comprising selecting, by the controller, the second configuration, responsive to the one or more second metrics of the second configuration satisfying the one or more criteria.

4. The method of claim 1, wherein determining to identify the second configuration further comprises:
calculating, by the controller, the one or more criteria by using the indication of demand for power within the worksite; and
identifying, by the controller, that the one or more metrics of the plurality of energy containers in the first configuration satisfies the one or more criteria.

5. The method of claim 1, further comprising calculating, by the controller, a plurality of configurations, different from the first configuration, having one or more metrics which satisfy the one or more criteria.

6. The method of claim 1, wherein modifying the configuration, further comprises:
removing, by the controller, at least one energy container of the plurality of energy containers within the first configuration according to the one or more criteria; and
calculating, by the controller, a rate to adjust one or more control parameters of each energy container within the second configuration to satisfy the indication of demand for power.

7. The method of claim 1, wherein modifying the configuration, further comprises:
adding, by the controller, at least one energy container of the plurality of energy containers within the first configuration according to the one or more criteria; and
calculating, by the controller, a rate to adjust one or more control parameters of each energy container within the second configuration to satisfy the indication of demand for power.

8. The method of claim 1, further comprising:
receiving, by the controller from the microgrid, a second indication of demand for power to complete second operations within the worksite, the microgrid supplied with power from one or more of the plurality of energy containers in the second configuration;
determining, by the controller, to identify a third configuration for the plurality of energy containers, based on the one or more second metrics of the second configuration as compared to the one or more criteria;
identifying, by the controller, the third configuration of the plurality of energy containers, having one or more third metrics which satisfy the one or more criteria; and
modifying, by the controller, the configuration of the plurality of energy containers to complete the second operations within the worksite, from the second configuration to the third configuration.

9. The method of claim 1, further comprising:
transmitting, by the controller to a main control system, the second configuration of the plurality of energy containers; and
receiving, by the controller from the main control system, a response indicating an approval or a denial of the second configuration of the plurality of energy containers.

10. The method of claim 1, wherein the one or more criteria include at least one of an indication of a power source, an indication of an energy source, prioritization between each energy container in the plurality of energy containers, thermal balancing, cyclic age balancing, or calendar age balancing.

11. The method of claim 8, wherein the first configuration of the plurality of energy containers differs from the second configuration of the plurality of energy containers, wherein the second configuration of the plurality of energy containers differs from the third configuration of the plurality of energy containers.

12. The method of claim 1, further comprising transmitting, by the controller to each energy container in the plurality of energy containers via a coupler system, a signal to pre-configure each energy container within the configuration.

13. A controller, comprising:
one or more processors coupled with memory storing instructions that, when executed by the one or more processors, cause the one or more processors to:
receive from a microgrid, an indication of demand for power to complete operations within a worksite, the microgrid supplied with power from one or more of a plurality of energy containers in a first configuration;
determine to identify a second configuration for the plurality of energy containers, one or more metrics of the first configuration as compared to one or more criteria;
identify the second configuration of the plurality of energy containers, which satisfies the one or more criteria; and
modify a configuration of the plurality of energy containers to complete the operations within the worksite, from the first configuration to the second configuration.

14. The controller of claim 13, the one or more processors to select the second configuration, responsive to the second configuration satisfying the one or more criteria.

15. The controller of claim 13, wherein, when determining to identify the second configuration, the one or more processors to:
calculate the one or more criteria by using the indication of demand for power within the worksite; and
identify that the one or more metrics of the plurality of energy containers in the first configuration satisfies the one or more criteria.

16. The controller of claim 15, the one or more processors to compare the power from the one or more of the plurality of energy containers in the first configuration with the one or more criteria.

17. The controller of claim 13, wherein, when modifying the configuration, the one or more processors to:
remove at least one energy container of the plurality of energy containers within the first configuration according to the one or more criteria; and
calculate a rate to adjust one or more control parameters of each energy container within the second configuration to satisfy the indication of demand for power.

18. The controller of claim 13, wherein, when modifying the configuration, the one or more processors to:
add at least one energy container of the plurality of energy containers within the first configuration according to the one or more criteria; and
calculate a rate to adjust one or more control parameters of each energy container within the second configuration to satisfy the indication of demand for power.

19. The controller of claim 13, the one or more processors to:
receive from the microgrid, a second indication of demand for power to complete second operations within the worksite, the microgrid supplied with power from one or more of the plurality of energy containers in the second configuration;
determine to identify a third configuration for the plurality of energy containers, one or more metrics of the second configuration as compared to one or more criteria;
identify the third configuration of the plurality of energy containers, which satisfies the one or more criteria; and
modify the configuration of the plurality of energy containers to complete the second operations within the worksite, from the second configuration to the third configuration.

20. A microgrid, comprising:
a plurality of energy containers to provide power to the microgrid according to an indication of demand for power to complete operations within a worksite; and
a controller comprising on or more processors coupled with memory to:
receive from the microgrid, the indication of demand for power to complete the operations within the worksite, the microgrid supplied with power from one or more of the plurality of energy containers in a first configuration;
determine to identify a second configuration for the plurality of energy containers, one or more metrics of the first configuration as compared to one or more criteria;
identify the second configuration of the plurality of energy containers, which satisfies the one or more criteria; and
modify a configuration of the plurality of energy containers to complete the operations within the worksite, from the first configuration to the second configuration.
